(19) United States
(12) Patent Application Publication
(10) Pub. No.: US 2001/0051197 A1
(43) Pub. Date: Dec. 13, 2001

(54) Low acid beverages supplemented with nutritional calcium sources

(75) Inventors: David Kee Yang, Cincinnati, OH (US); Matthew Thomas Heisey, Wyoming, OH (US); Mark Benson Andon, Fairfield, OH (US)

Correspondence Address: THE PROCTER & GAMBLE COMPANY, PATENT DIVISION, IVORYDALE TECHNICAL CENTER - BOX 474, 5299 SPRING GROVE AVENUE, CINCINNATI, OH, 45217, US

(73) Assignee: The Procter & Gamble Company

(21) Appl. No.: 09/893,841

(22) Filed: Jun. 28, 2001

Related U.S. Application Data
(63) Continuation of application No. 09/400,002, filed on Sep. 20, 1999.
Application No. 09/400,002 is a continuation-in-part of application No. 09/162,864, filed on Sep. 29, 1998, now abandoned.

(51) Int. Cl. A23L 1/304

(52) U.S. Cl. 426/74

(57) ABSTRACT

Low acid beverages can be further fortified with calcium without adversely affecting the taste or texture of the beverage. These products have a more bioavailable source of calcium and contain an additional 3% to 100% of the recommended daily allowance of calcium per unit serving. Calcium fortified water compositions of the present invention have elemental calcium concentrations up to 850 ppm. The added calcium source that is used to fortify the beverages of the present invention is added directly to the beverages of the present invention or may be added in the form of at least one premix.

### CROSS REFERENCE TO RELATED APPLICATIONS

This is a Continuation-in-Part of co-pending application Ser. No. 09/162,864 filed Sep. 29, 1998.

### TECHNICAL FIELD

This invention relates to low acid beverages which are nutritionally supplemented with significant levels of calcium. More particularly, this invention relates to water and fluid milk which can be fortified with calcium without adversely affecting their taste or texture. These fortified products have a bioavailable source of additional calcium.

### BACKGROUND OF THE INVENTION

Osteoporosis, a degenerative bone disease, is recognized as a major public health problem in many countries. It is the most common skeletal disease in the world and results in a significant burden to the population in terms of quality of life and medical expense.

Dietary calcium deficiency has been determined by medical authorities to be an important risk factor for osteoporosis. Calcium is the basic building block of bone, and the need for calcium in our daily diet has been extensively documented in medical and scientific journals. In addition, many government and public health agencies have recommended that individuals strive to include optimal amounts of calcium in their diet to reduce risk for osteoporosis.

Calcium is an essential nutrient needed throughout life, for a number of important physiologic functions. It is reported that ninety-nine percent of the body's calcium is present in teeth and bones. Therefore, calcium is needed for both formation and maintenance of bones and teeth. The remaining one percent of calcium is located throughout the body in the blood and soft tissues and is ionized in part. In its ionized form, calcium is of great importance for blood coagulation, proper functioning of the heart, nerves, and muscles, and in the permeability of membranes. Current scientific research shows evidence that calcium plays a role in protecting against high blood pressure and colon cancer. If there are inadequate amounts of calcium from dietary sources, skeletal calcium will be sacrificed to satisfy the metabolic needs of the soft tissues. Thus, when dietary calcium intake is inadequate, skeletal metabolism is compromised. Under this circumstance, less bone is accumulated during growth and calcium is withdrawn from the adult skeleton with a concomitant reduction of bone strength. Both of these situations appear to predispose a person to osteoporosis and its consequent fractures.

In many parts of the world, calcium intakes fall well below the recommended amounts. Although nutritionists have stressed the importance of receiving the daily nutritional requirements of calcium in the diet, it is difficult to achieve the required amount of calcium through a regular diet. Taking dietary supplements is one way to ingest additional calcium; however, the body typically absorbs only a minority of the calcium that is ingested via supplementation. In addition to increasing calcium intake via supplementation, calcium intake can be increased by ingesting fluids or foods that have been calcium fortified. Increasing calcium intake via ingesting calcium fortified fluids is particularly desired as mammals must ingest fairly high levels of fluids for daily survival. As a result, a calcium fortified fluid, particularly a calcium fortified water product that contains a significant concentration of calcium, would be highly effective in delivering the quantity of daily calcium that would meet daily nutritional requirements.

Unfortunately, the development of calcium fortified fluids has met with numerous technical obstacles. In particular, previous attempts at producing calcium fortified fluids, have resulted in products that have low calcium concentrations, suspension settlement issues, require exceptionally long processing times, have unacceptable off flavors that are described as bitter, metallic, chalky, and “minerally”, poor textures or a combination of these drawbacks. For example, insoluble calcium salts need to be added to products as a suspension, but this often leads to negative changes in taste and texture as well as suspension settlement—a phenomenon wherein solid particles separate out from the liquid phase of the suspension and settle onto the bottom of the vessel. In addition, insoluble calcium sources are generally less bioavailable than soluble forms. Although some inorganic salts of calcium, such as calcium salts of bicarbonate, chloride, sulfate and some phosphates, possess a solubility which allows relatively high levels of calcium to be added to water, they produce unacceptable off tastes. While attempts have been made to cover up the off flavors or poor textures of previous calcium fortified beverages, such efforts have required the addition of materials such as sugars, artificial sweeteners, and flavorings. Typically, these attempts at resolving the technical hurdles of calcium fortification technology have resulted in the addition of “hollow calories” or materials such as artificial sweeteners that may detract from the overall health of the consumer. In short, there remains a need for calcium fortified beverages that, effectively and efficiently deliver calcium without delivering nonessential materials that may detract from the consumer's overall health, and that can be readily produced and stored until use. In addition, since beverages that taste bad will not be used, there remains a need for a calcium fortified beverages that have acceptable hedonic properties.

Calcium fortified water is especially valuable as it may be stored at room temperature, consumed in large quantites without contributing “empty calories” and can serve as a fluid calcium source for those who cannot consume milk due to lactose intolerance. Examples of previous attempts at producing a hedonically acceptable calcium fortified water product include:

U.S. Pat. No. 5,716,649 which discloses a process for increasing the calcium content of water to 200 to 500 mg per liter by sealing water in a stainless steel mixing tank along with a tin catalyst and a glass fibrous material. This mixture is then heated for 15 days and then slowly cooled during a 135 day period to complete the process.

U.S. Pat. No. 4,325,975 which discloses a drinking water product which is sodium and potassium free, contains from 60 to 125 mg of calcium per liter of product, and contains smaller amounts of the essential mineral magnesium and the non-nutritionally essential elements strontium and lithium.

U.S. Pat. No. 4,851,221 which discloses a potable liquid suitable for dietary calcium supplementation consisting essentially of calcium hydroxide, calcium carbonate or calcium oxide and citric acid.

U.S. Pat. No. 5,232,709 which discloses a calcium fortified chocolate powder mix that contains 0.05% calcium citrate malate, non-fat dry milk, cocoa powder, small amounts of colors, salt and other compounds and 66.88% sucrose.

In each of these patents the fortified water or beverage product that is disclosed fails to meet at least one of the desired parameters of a fluid calcium source. Thus, there clearly remains a need for a calcium fortified water product that is hedonically acceptable and provides the necessary calcium, while at the same time being readily produced and conveniently stored.

Like calcium fortified water, calcium fortified milk products have been developed and used in the past. By increasing the amount of calcium in water and milk via supplementation, it is possible for people to more easily meet their nutritional requirement for calcium. In addition, calcium is best absorbed when accompanied by vitamin D and lactose, both of which are present in milk. These products are generally fortified with insoluble calcium salts to avoid milk protein instability and coagulation. As stated hereinbefore, insoluble calcium salts in milk and other low acid beverages lead to negative taste and texture attributes, as well as cause suspension settlement during product storage. Furthermore, insoluble calcium salts are absorbed less by the body than soluble forms of calcium. On the other hand, the addition of certain highly soluble calcium salts for fortification of milk cause disruption of the ionic balance of the milk which leads to protein destabilization and the formation of a precipitate.

U.S. Pat. No. 4,840,814 discloses a process for making calcium enriched milk which does not coagulate upon boiling. The process generally comprises sterilizing and cooling the milk, upwardly adjusting the pH of the milk to above 6.7 using an alkaline reagent, adding calcium to the milk in the form of a water-soluble calcium salt of an organic acid and lowering the pH of the milk.

EP 586 016 A1 describes calcium fortified powdered milk products and a process for making them. The process comprises blending a milk product with a calcium fortification system to form a calcium fortified mixture, cooling said calcium fortified mixture down to a temperature effective to initiate lactose crystallization, and dehydrating said calcium fortified mixture.

U.S. Pat. No. 4,701,329 discloses calcium enriched and phosphorous enriched fortified milk which provides minimal settling of the calcium source, acceptable flavor, and acceptable viscosity and mouth-feel. The fortified milk may contain up to 100% of the U.S. RDA of calcium, and is made by the addition of tri-basic calcium phosphate, carrageenan, and guar gum to fresh milk before pasteurization.

Investigators Rasyid and Hansen report in an article in Food Hydrocolloids, Vol. 4, No.5, pp 415-422 (1991), that a high calcium soy milk is prepared wherein calcium gluconate is employed as a calcium source. The preparation also contains a calcium sequestering agent (sodium hexametaphosphate) and a calcium gluconate stabilizing agent. The resultant soy milk is reported to possess a calcium content which is comparable to bovine milk and which has satisfactory heat stability.

By the present invention, low acid beverage products, like water and milk are fortified with calcium. The resulting formulations provide a more bioavailable source of calcium and excellent solubility without negatively affecting taste, texture and, in the case of milk, protein stability. In addition, the calcium fortified water product is readily produced and can be stored for long periods of time without refrigeration, while the fortified milk product of the present invention is suitable for use as an ingredient to use in any product where milk is used, including but not limited to dry powdered milk, hard cheese, cottage cheese, farmer's cheese, pot cheese, creamy soups, sauces, puddings, yogurts, ice creams, and nutritional drinks and shakes. These and other advantages of the present invention will be seen from the disclosures hereinafter.

### SUMMARY OF THE INVENTION

A calcium source composition comprising at least one member selected from the group consisting of: a mixed organic acid salt of calcium; a mixture comprising an acidic calcium salt and an organic acid salt of calcium; a mixture comprising an acidic calcium salt and a mixed organic acid salt of calcium; a mixture comprising an acidic calcium salt, an organic acid salt of calcium and a mixed organic acid salt of calcium; a mixture comprising an acidic calcium salt, a basic calcium salt and an organic acid; a mixture comprising an acidic calcium salt, a basic calcium salt, an organic acid and a mixed organic acid salt of calcium; a mixture comprising an acidic calcium salt, a basic calcium salt, an organic acid and an organic acid salt of calcium; a mixture comprising an acidic calcium salt, a basic calcium salt, an organic acid, an organic acid salt of calcium and a mixed organic acid salt of calcium; a mixture comprising a basic calcium salt and an organic acid salt of calcium; a mixture comprising a basic calcium salt and a mixed organic acid salt of calcium; a mixture comprising an organic acid salt of calcium and a mixed organic acid salt of calcium; a mixture comprising a basic calcium salt, an organic acid salt of calcium and a mixed organic acid salt of calcium; a mixture comprising a basic calcium salt, an organic acid and an organic acid salt of calcium; a mixture comprising a basic calcium salt, an organic acid and a mixed organic acid salt of calcium; a mixture comprising a basic calcium salt, an organic acid, an organic acid salt of calcium and a mixed organic acid salt of calcium; an organic acid salt of calcium; a mixture comprising an acidic calcium salt and a basic calcium salt; a mixture comprising an acidic calcium salt, a basic calcium salt and an organic acid salt of calcium; a mixture comprising an acidic calcium salt, a basic calcium salt and a mixed organic acid salt of calcium; a mixture comprising an acidic calcium salt, a basic calcium salt, an organic acid salt of calcium and a mixed organic acid salt of calcium; a mixture comprising a basic calcium salt and at least two organic acids; and mixtures thereof.

A calcium fortified water composition comprising water and a sufficient amount of an added calcium source to provide said calcium fortified water composition with a total elemental calcium concentration of 850 ppm or less.

A process for producing a calcium fortified water composition, that contains a sufficient amount of an added calcium source to provide said calcium fortified water composition with a total elemental calcium concentration of 850 ppm or less, the process comprising the steps of:

a.) providing a calcium source wherein said calcium source's components are selected from the group consisting of acidic calcium salts, basic calcium salts, organic acids, organic acid salts of calcium, mixed organic acid salts of calcium and mixtures thereof;

b.) adding said components of said calcium source to water.

A process for producing a calcium fortified water composition, that contains a sufficient amount of an added calcium source to provide said calcium fortified water composition with a total elemental calcium concentration of 850 ppm or less, the process comprising the steps of:

a.) providing a calcium source wherein said calcium source's components are selected from the group consisting of acidic calcium salts, basic calcium salts, organic acids, organic acid salts of calcium, mixed organic acid salts of calcium and mixtures thereof;

b.) preparing at least one aqueous premix comprising at least one component of said calcium source;

c.) adding the premixes and any remaining components of said calcium source directly to water.

A calcium fortified low acid beverage product which comprises an additional 3% to 100% RDA calcium per unit serving added as calcium citrate malate is claimed. This calcium fortified milk product is prepared by a process comprising the steps of (1) preparing an aqueous premix of neutral calcium citrate malate and (2) either (a) adding the calcium citrate malate premix directly to the low acid beverage prior to processing, for example, pasteurization and/or sterilization, or (b) adding the calcium citrate malate premix, optionally processed to achieve commercial sterility, for example, microfiltration or UV treatment, directly to a pasteurized/sterilized processed beverage.

Specifically, in the case of milk, the calcium citrate malate containing aqueous premix can be added to milk directly prior to pasteurization or optionally processed to achieve commercial sterility and added in a post-pasteurization step. At fortification levels above about 40%, a post pasteurization process is generally preferred; at fortification levels below about 40%, the calcium citrate malate can be added directly to the milk and pasteurized in the standard fashion, with substantially no negative effects. Preferably, neutral calcium citrate malate is formed in a soluble aqueous premix and added to the milk at the appropriate weight ratio to meet the required 8.25% milk solids non-fat standard (MSNF).

### DETAILED DESCRIPTION OF THE INVENTION

As used herein, the term “low acid beverage” or “low acid beverage products” refers to beverages which include but are not limited to water where the pH is from about 3.0 to 10.0, preferably 4.0 to 7.0 and “protein-based drinks” having a pH from 4.2 to 7.0, including, preferably, cow's milk, as well as other protein based drinks including, soy milk, meal replacement beverages, infant formulas and mixtures thereof.

As used herein, the term water includes, but is not limited to, any potable water such as spring water, sterilized water, filtered water, reverse osmosis water, distilled water, carbonated or sparkling water, purified water, artesian water, ground water, mineral water, well water, municipal water, and mixtures thereof. Said water may or may not have a calcium concentration prior to being calcium fortified.

As used herein, the term “calcium fortified water” means water to which a calcium source has been added.

As used herein, the term “elemental calcium” means the amount of calcium present as opposed to the amount of a calcium source ingredient present as the calcium source contains calcium as well as other constituents.

As used herein, the term “total elemental calcium concentration” equals the sum of any calcium present, prior to calcium fortification, and the amount of calcium added by the calcium source of the present invention divided by the volume of the low acid beverage. The definition is expressed mathematically as follows:

Total elemental calcium concentration=(x+y)/z

Wherein

x=calcium present prior to calcium fortification

y=calcium added by the calcium source of the present invention

z=volume of the low acid beverage

As used herein “ppm” refers to parts per million of total elemental calcium concentration, for example, milligrams of calcium per one liter of water.

As used herein, the term “fluid milk products” refers to skimmed milk, lowfat milk, whole milk, nonfat milk, condensed milk, filled milk, and evaporated milk, all in their liquid form.

As used herein, the term “protein-based drink” refers to any beverage which contains four or more grams of protein per serving.

As used herein, the term “meal replacement beverage” refers to any beverage providing complete nutrition, including the vitamins and minerals known to be essential for human health, as well as protein, carbohydrate and fat, for example, including but not limited to Slimfast®, Ensure®, and Boost®.

As used herein, the term “nutritional” or “nutritionally supplemented” amount means that the calcium source used in the practice of this invention provides a nourishing amount of calcium. The nutritionally supplemented amount will generally comprise more than 3% of the Recommended Daily Allowance (RDA), preferably from about 10% to about 100% RDA, most preferably from about 10% to about 40% of the RDA, per unit portion of the food or beverage product. It must be recognized that the preferred daily intake of any mineral may vary with the user. For example, pregnant, lactating, or post-menopausal women may require an increased calcium intake over the RDA. In general, the RDA of calcium will range from 360 mg to 1200 mg, depending on the age, body weight, and gender of the individual.

As used herein, the term “achieve microbial stability” or “achieving microbial stability” refers to the use of processes involving chemical or physical treatments to inactivate, reduce in number, and/or slow the growth of microorganisms such that a product may be used in the marketplace as intended without poising a significant health risk from microbiological contamination. These treatments include, but are not limited to, refrigeration, chemical preservatives, thermal processing, ozonation treatment, microfiltration, acidification, irradiation, ultraviolet light, high intensity pulsed electric fields, pressure, carbonation, sonication, and combinations thereof.

As used herein, the term “pasteurized” or “pasteurization” refers to treatment processes where materials are heated, without radiation, to temperatures and for periods of time sufficient to at least partially sterilize the material against microbial, mold growth and yeast, without substantial alteration of the chemical composition of the material. The terms “pasteurize” and “pasteurization” include the more restrictive terms “sterilize” and “sterilization” where the treated material is substantially free of microbial and mold growth.

As used herein, the term “hedonics” refers to the overall acceptability of the calcium fortified water products of the present invention based upon the combined sensory attributes of taste, smell, mouth feel, and appearance when the attributes are graded in the context of how a calcium fortified water product is expected to taste, appear, smell and feel. A calcium fortified water product is hedonically acceptable if, on average, the product's hedonic score is 5 or greater on a scale of 1 to 9. The hedonic acceptability of the calcium fortified water products of the present invention can be assessed with panelists using a discrete rating scale ranging from 1 to 9 points wherein 9 corresponds to the descriptor “like extremely”, 8 corresponds to the descriptor “like very much”, 7 corresponds to the descriptor “like moderately”, 6 corresponds to the descriptor “like slightly”, 5 corresponds to the descriptor “neither like nor dislike”, 4 corresponds to the descriptor “dislike slightly”, 3 corresponds to the descriptor “dislike moderately”, 2 corresponds to the descriptor “dislike very much”, 1 corresponds to the descriptor “dislike extremely”. Regular consumers of bottled water serve as panelists. A panel consists of a sufficiently large number of panelists to provide a statistically valid result that has a confidence interval of at least 95%. During the test, the panelists read a product concept description which explains the nature, content, and benefits of calcium fortified water. After reading the concept, the panelists consume a plain cracker, then they consume as much of the calcium fortified water as needed to give a numeric ranking of 1 to 9 as per the scale described above.

As used herein the articles a and an when used in a claim, for example, “a basic calcium salt” or “an organic acid salt of calcium” is understood to mean at least one of the components that are claimed or described.

### Calcium Fortified Water Products

Suprisingly, Applicants have found that hedonically acceptable calcium fortified water, that has the desired calcium solubility, as well as the desired calcium concentrations, may be obtained by adding specific calcium source formulations to water, based on the range of desired total elemental calcium in the calcium fortified water. Notably, the calcium fortified water of the present invention provides the advantages of a calcium fortified beverage without resorting to the addition of flavorings and sweeteners to cover up off flavors and poor texture. In short, acceptable hedonics are obtained without resorting to flavorings or sweeteners. However, sweeteners and flavorings may be added in such a manner to the embodiments of the present invention so as to not detract from the present invention's hedonics or calcium delivery capability. In addition, unlike some previously disclosed calcium fortified water products, the calcium fortified water products of the present invention may be produced and microbially stabilized with a minimum of processing effort and time.

Added calcium source formulations that can be used to produce a calcium fortified water having a total elemental calcium concentration of from about 1 ppm to about 171 ppm comprise at least one member selected from the group consisting of:

a.) an organic acid salt of calcium;

b.) a mixed organic acid salt of calcium;

c.) a mixture comprising an acidic calcium salt and an organic acid salt of calcium;

d.) a mixture comprising an acidic calcium salt and a mixed organic acid salt of calcium;

e.) a mixture comprising an acidic calcium salt, an organic acid salt of calcium and a mixed organic acid salt of calcium;

f.) a mixture comprising an acidic calcium salt, a basic calcium salt and an organic acid;

g.) a mixture comprising an acidic calcium salt, a basic calcium salt, an organic acid and a mixed organic acid salt of calcium;

h.) a mixture comprising an acidic calcium salt, a basic calcium salt, an organic acid and an organic acid salt of calcium;

i.) a mixture comprising an acidic calcium salt, a basic calcium salt, an organic acid, an organic acid salt of calcium and a mixed organic acid salt of calcium;

j.) a mixture comprising a basic calcium salt and an organic acid;

k.) a mixture comprising a basic calcium salt and an organic acid salt of calcium;

l.) a mixture comprising a basic calcium salt and a mixed organic acid salt of calcium;

m.) a mixture comprising an organic acid salt of calcium and a mixed organic acid salt of calcium;

n.) a mixture comprising a basic calcium salt, an organic acid salt of calcium and a mixed organic acid salt of calcium;

o.) a mixture comprising a basic calcium salt, an organic acid and an organic acid salt of calcium;

p.) a mixture comprising a basic calcium salt, an organic acid and a mixed organic acid salt of calcium;

q.) a mixture comprising a basic calcium salt, an organic acid, an organic acid salt of calcium and a mixed organic acid salt of calcium;

r.) an acidic calcium salt:

s.) a basic calcium salt;

t.) a mixture comprising an acidic calcium salt and a basic calcium salt;

u.) a mixture comprising an acidic calcium salt, a basic calcium salt and an organic acid salt of calcium;

v.) a mixture comprising an acidic calcium salt, a basic calcium salt and a mixed organic acid salt of calcium;

w.) a mixture comprising an acidic calcium salt, a basic calcium salt, an organic acid salt of calcium and a mixed organic acid salt of calcium;

x.) mixtures thereof.

The added calcium source is added in a sufficient amount to water to produce a calcium fortified water having a total elemental calcium concentration of from about 1 ppm to about 171 ppm.

Added calcium source formulations that can be used to produce a calcium fortified water having a total elemental calcium concentration of from about 171 ppm to about 341 ppm comprise at least one member selected from the group consisting of:

a.) an organic acid salt of calcium;

b.) a mixed organic acid salt of calcium;

c.) a mixture comprising an acidic calcium salt and an organic acid salt of calcium;

d.) a mixture comprising an acidic calcium salt and a mixed organic acid salt of calcium;

e.) a mixture comprising an acidic calcium salt, an organic acid salt of calcium and a mixed organic acid salt of calcium;

f.) a mixture comprising an acidic calcium salt, a basic calcium salt and an organic acid;

g.) a mixture comprising an acidic calcium salt, a basic calcium salt, an organic acid and a mixed organic acid salt of calcium;

h.) a mixture comprising an acidic calcium salt, a basic calcium salt, an organic acid and an organic acid salt of calcium;

i.) a mixture comprising an acidic calcium salt, a basic calcium salt, an organic acid, an organic acid salt of calcium and a mixed organic acid salt of calcium;

j.) a mixture comprising a basic calcium salt and an organic acid;

k.) a mixture comprising a basic calcium salt and an organic acid salt of calcium;

l.) a mixture comprising a basic calcium salt and a mixed organic acid salt of calcium;

m.) a mixture comprising an organic acid salt of calcium and a mixed organic acid salt of calcium;

n.) a mixture comprising a basic calcium salt, an organic acid salt of calcium and a mixed organic acid salt of calcium;

o.) a mixture comprising a basic calcium salt, an organic acid and an organic acid salt of calcium;

p.) a mixture comprising a basic calcium salt, an organic acid and a mixed organic acid salt of calcium;

q.) a mixture comprising a basic calcium salt, an organic acid, an organic acid salt of calcium and a mixed organic acid salt of calcium; and

r.) mixtures thereof. =ps Preferably, the added calcium source formulation comprises at least one member selected from the group consisting of:

a.) a mixture comprising an acidic calcium salt and an organic acid salt of calcium;

b.) a mixture comprising an acidic calcium salt and a mixed organic acid salt of calcium;

c.) a mixture comprising an acidic calcium salt, an organic acid salt of calcium and a mixed organic acid salt of calcium;

d.) a mixture comprising an acidic calcium salt, a basic calcium salt and an organic acid;

e.) a mixture comprising an acidic calcium salt, a basic calcium salt, an organic acid and a mixed organic acid salt of calcium;

f.) a mixture comprising an acidic calcium salt, a basic calcium salt, an organic acid and an organic acid salt of calcium;

g.) a mixture comprising an acidic calcium salt, a basic calcium salt, an organic acid, an organic acid salt of calcium and a mixed organic acid salt of calcium; and

h.) mixtures thereof;

wherein from about 1% to about 90%, preferably from about 1% about 65% and most preferably from about 5% to about 30% of the total elemental calcium concentration of said calcium fortified water is obtained from an acidic calcium salt or mixtures of acidic calcium salts. The added calcium source is added in a sufficient amount to water to produce a calcium fortified water having a total elemental calcium concentration of from about 171 ppm to about 341 ppm.

Added calcium source formulations that can be used to produce a calcium fortified water having a total elemental calcium concentration of from about 341 ppm to about 511 ppm comprise at least one member selected from the group consisting of:

a.) an organic acid salt of calcium;

b.) a mixed organic acid salt of calcium;

c.) a mixture comprising an acidic calcium salt and an organic acid salt of calcium;

d.) a mixture comprising an acidic calcium salt and a mixed organic acid salt of calcium;

e.) a mixture comprising an acidic calcium salt, an organic acid salt of calcium and a mixed organic acid salt of calcium;

f.) a mixture comprising an acidic calcium salt, a basic calcium salt and an organic acid;

g.) a mixture comprising an acidic calcium salt, a basic calcium salt, an organic acid and a mixed organic acid salt of calcium;

h.) a mixture comprising an acidic calcium salt, a basic calcium salt, an organic acid and an organic acid salt of calcium;

i.) a mixture comprising an acidic calcium salt, a basic calcium salt, an organic acid, an organic acid salt of calcium and a mixed organic acid salt of calcium;

j.) a mixture comprising a basic calcium salt and an organic acid;

k.) a mixture comprising a basic calcium salt and an organic acid salt of calcium;

l.) a mixture comprising a basic calcium salt and a mixed organic acid salt of calcium;

m.) a mixture comprising an organic acid salt of calcium and a mixed organic acid salt of calcium;

n.) a mixture comprising a basic calcium salt, an organic acid salt of calcium and a mixed organic acid salt of calcium;

o.) a mixture comprising a basic calcium salt, an organic acid and an organic acid salt of calcium;

p.) a mixture comprising a basic calcium salt, an organic acid and a mixed organic acid salt of calcium;

q.) a mixture comprising a basic calcium salt, an organic acid, an organic acid salt of calcium and a mixed organic acid salt of calcium; and

r.) mixtures thereof.

Preferably, the added calcium source formulation comprises at least one member selected from the group consisting of:

a.) a mixture comprising an acidic calcium salt and an organic acid salt of calcium;

b.) a mixture comprising an acidic calcium salt and a mixed organic acid salt of calcium;

c.) a mixture comprising an acidic calcium salt, an organic acid salt of calcium and a mixed organic acid salt of calcium;

d.) a mixture comprising an acidic calcium salt, a basic calcium salt and an organic acid;

e.) a mixture comprising an acidic calcium salt, a basic calcium salt, an organic acid and a mixed organic acid salt of calcium;

f.) a mixture comprising an acidic calcium salt, a basic calcium salt, an organic acid and an organic acid salt of calcium;

g.) a mixture comprising an acidic calcium salt, a basic calcium salt, an organic acid, an organic acid salt of calcium and a mixed organic acid salt of calcium; and

h.) mixtures thereof;

wherein from about 1% to about 60%, preferably from about 1% to about 45% and most preferably from about 5% to about 25% of the total elemental calcium concentration of said calcium fortified water is obtained from an acidic calcium salt or mixtures of acidic calcium salts. The added calcium source is added in a sufficient amount to provide to water to produce a calcium fortified water having a total elemental calcium concentration of from about 341 ppm to about 511 ppm.

Added calcium source formulations that can be used to produce a calcium fortified water having a total elemental calcium concentration of from about 511 ppm to about 850 ppm comprise at least one member selected from the group consisting of:

a.) an organic acid salt of calcium;

b.) a mixed organic acid salt of calcium;

c.) a mixture comprising an acidic calcium salt and an organic acid salt of calcium;

d.) a mixture comprising an acidic calcium salt and a mixed organic acid salt of calcium;

e.) a mixture comprising an acidic calcium salt, an organic acid salt of calcium and a mixed organic acid salt of calcium;

f.) a mixture comprising an acidic calcium salt, a basic calcium salt and an organic acid,

g.) a mixture comprising an acidic calcium salt, a basic calcium salt, an organic acid and a mixed organic acid salt of calcium;

h.) a mixture comprising an acidic calcium salt, a basic calcium salt, an organic acid and an organic acid salt of calcium;

i.) a mixture comprising an acidic calcium salt, a basic calcium salt, an organic acid, an organic acid salt of calcium and a mixed organic acid salt of calcium;

j.) a mixture comprising a basic calcium salt and an organic acid;

k.) a mixture comprising a basic calcium salt and an organic acid salt of calcium;

o.) a mixture comprising a basic calcium salt and a mixed organic acid salt of calcium;

m.) a mixture comprising an organic acid salt of calcium and a mixed organic acid salt of calcium;

n.) a mixture comprising a basic calcium salt, an organic acid salt of calcium and a mixed organic acid salt of calcium;

o.) a mixture comprising a basic calcium salt, an organic acid and an organic acid salt of calcium;

p.) a mixture comprising a basic calcium salt, an organic acid and a mixed organic acid salt of calcium;

q.) a mixture comprising a basic calcium salt, an organic acid, an organic acid salt of calcium and a mixed organic acid salt of calcium; and

r.) mixtures thereof.

Preferably, the added calcium source formulation comprises at least one member selected from the group consisting of:

a.) a mixture comprising an acidic calcium salt and an organic acid salt of calcium;

b.) a mixture comprising an acidic calcium salt and a mixed organic acid salt of calcium;

c.) a mixture comprising an acidic calcium salt, an organic acid salt of calcium and a mixed organic acid salt of calcium;

d.) a mixture comprising an acidic calcium salt, a basic calcium salt and an organic acid;

e.) a mixture comprising an acidic calcium salt, a basic calcium salt, an organic acid and a mixed organic acid salt of calcium;

f.) a mixture comprising an acidic calcium salt, a basic calcium salt, an organic acid and an organic acid salt of calcium;

g.) a mixture comprising an acidic calcium salt, a basic calcium salt, an organic acid, an organic acid salt of calcium and a mixed organic acid salt of calcium; and

h.) mixtures thereof;

wherein from about 1% to about 40%, preferably from about 1% to about 30% and most preferably from about 5% to about 20% of the total elemental calcium concentration of said calcium fortified water composition is obtained from an acidic calcium salt or mixtures of acidic calcium salts. The added calcium source is added in a sufficient amount to provide to water to produce a calcium fortified water composition having a total elemental calcium concentration of from about 511 ppm to about 850 ppm.

Components of the added calcium source are selected from the group consisting of an organic acid, a basic calcium salt, an organic acid salt of calcium and a mixed organic acid salt of calcium and an acidic calcium salt. Organic acids that can be used to practice the present invention include: citric acid, malic acid, gluconic acid, adipic acid, lactic acid, acetic acid, succinic acid, fumaric acid, pyruvic acid and ascorbic acid. When at least two different organic acids are combined with a basic calcium salt, the water solubility of the calcium is enhanced. The preferred organic acids used in producing embodiments of the present invention, having a total elemental calcium concentration of from about 341 ppm to about 850 ppm, include: citric acid, malic acid, gluconic acid, lactic acid, and fumaric acid. Basic calcium salts that can be used to practice the present invention include calcium hydroxide, calcium oxide, and calcium carbonate. Organic acid salts of calcium that can be used to practice the present invention include: calcium citrate, calcium malate, calcium gluconate, calcium adipate, calcium lactate, calcium acetate, calcium succinate, calcium fumarate, calcium pyruvate and calcium ascorbate. The preferred organic acid salts used in producing embodiments of the present invention, having a total elemental calcium concentration of from about 341 ppm to about 850 ppm, include: calcium citrate, calcium malate, calcium gluconate, calcium lactate, calcium fumarate. Acidic calcium salts that can be used to practice the present invention include calcium chloride, calcium sulfate and calcium phosphates.

Mixed organic acid salts of calcium that can be used to practice the present invention include: salts comprising a calcium cation, a citrate anion and at least one member selected from the group consisting of malate, gluconate, lactate, fumarate, succinate, adipate, acetate, pyruvate and ascorbate anions; salts comprising a calcium cation, a malate anion and at least one member selected from the group consisting of gluconate, lactate, fumarate, succinate, adipate, acetate, pyruvate and ascorbate anions; salts comprising a calcium cation, a gluconate anion and at least one member selected from the group consisting of lactate, fumarate, succinate, adipate, acetate, pyruvate and ascorbate anions; salts comprising a calcium cation, a lactate anion and at least member selected from the group consisting of fumarate, succinate, adipate, acetate, pyruvate and ascorbate anions; salts comprising a calcium cation, a fumarate anion and at least one member selected from the group consisting of succinate, adipate, acetate, pyruvate and ascorbate anions; salts comprising a calcium cation, a succinate anion and at least one member selected from the group consisting of adipate, acetate, pyruvate and ascorbate anions; salts comprising a calcium cation, an adipate anion and at least one member selected from the group consisting of acetate, pyruvate and ascorbate anions; salts comprising a calcium cation, an acetate anion and a member selected from the group consisting of pyruvate and ascorbate anions; salts comprising a calcium cation, pyruvate and ascorbate anions.

The preferred mixed organic acid salts of calcium, used in producing embodiments of the present invention, having a total elemental calcium concentration of from about 341 ppm to about 850 ppm, include: salts comprising a calcium cation, a citrate anion and at least one member selected from the group consisting of malate, gluconate, lactate and fumarate anions; salts comprising a calcium cation, a malate anion and at least one member selected from the group consisting of gluconate, lactate and fumarate anions; salts comprising a calcium cation, a gluconate anion and at least one member selected from the group consisting of lactate and fumarate anions; salts comprising a calcium cation, and lactate and fumarate anions.

Preferred forms of the mixed organic acid salt of calcium, calcium citrate malate, are forms having a mole ratio of calcium:citrate:malate which results in a total ionic charge from −100 to 100. Preferred forms of the salt can be expressed as those forms having a mole ratio of calcium:citrate:malate such that the following mathematical expression is true:

[−100≦(2x−3y−2z)≦100] Equation 1:

Wherein:

x=indexed moles calcium

y=indexed moles citrate

z=indexed moles malate

The total ionic charge is calculated by first determining the number of moles of calcium, citrate and malate present. Then, the number of moles of calcium is indexed to a value of 100 and the number of moles of citrate and malate are expressed as a proportion relative to 100. Finally, the indexed mole quantities are entered into Equation 1 above where they multiplied by their respective full ionic charge and then summed.

Forms of the salt wherein the mole ratio of calcium:citrate:malate is from −100 to 0 are particularly preferred. Particularly preferred forms of the salt can be expressed as those forms having a mole ratio of calcium:citrate:malate such that the following mathematical expression is true:

[−100≦(2x−3y−2z)≦0] Equation 2:

Wherein:

x=indexed moles calcium

y=indexed moles citrate

z=indexed moles malate

### Preparation of Calcium Fortified Water Products

The calcium fortified water products of the present invention may be produced by adding a sufficient amount of added calcium source to water to obtain the desired elemental calcium concentration or by adding the appropriate amount of water to a pre-weighed amount of calcium source. Preferably, when the added calcium source is added to water, any organic acid or mixture of organic acids is added first.

Alternately, at least one aqueous premix comprising at least one component of the calcium source may be prepared. The premix(s) and any remaining components of the calcium source are then added directly to water. Preferably, any organic acid or mixtures of organic acids are added to the water before any premix or any other component of the calcium source. Most preferably, any premix that comprises at least one organic acid is added to water after any organic acid or mixture of organic acids is added to water but before the addition of any other component of the calcium source.

Preferably, the calcium fortified water products of the present invention are microbially stable. The processing methods used to achieve microbial stability will depend on the particular calcium salts and organic acids used. Treatment of the water with ozone can be inadequate to achieve microbial stability depending on the composition of the product. For example, the presence of malic acid was found to rapidly degrade ozone. Thus, ozonation is inappropriate as a sole method for achieving microbial stability in all compositions. Thermal processing can be used with more highly thermodynamically stable compositions but can cause less stable compositions to precipitate. Chemical preservatives generally have little activity above neutral pH but, can be used to help achieve micro stability at acidic and neutral pH. Other composition dependent methods that can be used to achieve microbial stability of the calcium fortified water compositions of the present invention include: microfiltration, irradiation, ultraviolet light, high intensity pulsed electric fields, pressure, carbonation, sonication, and combinations thereof. Preferred methods for achieving microbial stability are ozonation, microfiltration, ultraviolet light, carbonation, thermal processing and mixtures thereof.

### EXAMPLES

The following examples illustrate the calcium fortified water compositions of the present invention, but are not intended to be limiting thereof.

### Example 1

1000 mL of calcium fortified water having an average hedonic score of at least 5 and containing 633 ppm calcium was made as follows:

a.) 1.034 g citric acid and 1.082 g malic acid were dissolved in 900 ml of water.

b.) 1.173 g calcium hydroxide was added to 100 ml of water.

c.) The 100 mL of calcium hydroxide mixture was added to the 900 mL of acid solution and mixed until clear.

### Example 2

1000 mL of calcium fortified, sparkling water having an average hedonic score of at least 5 and containing 844 ppm calcium was made as follows:

a.) 1.377 g citric acid and 1.442 g malic acid were dissolved in 900 mL water.

b.) 1.563 g calcium hydroxide was added to 100 ml of water.

c.) The 100 mL of calcium hydroxide mixture was added to the 900 mL of acid solution and mixed until clear.

d.) 1000 mL of calcium fortified water was carbonated with 4 volumes of carbon dioxide to form a calcium fortified sparkling water containing 844 ppm calcium.

### Example 3

1000 mL of calcium fortified water having an average hedonic score of at least 5 and containing 821 ppm calcium is made as follows:

a.) 7.046 g calcium gluconate, 0.305 g calcium hydroxide, and 0.50 g fumaric acid are combined to form a calcium source.

b.) The calcium source is added to 1000 mL of water with stirring until the calcium source dissolved.

### Example 4

1000 mL of calcium fortified water having an average hedonic score of at least 5 and containing 640 ppm calcium is made as follows:

a.) A first aliquot comprising 100 mL of water is heated to 50 degrees C.

b.) 11.7 g malic acid and 11.8 g lactic acid are dissolved in the first aliquot of heated water.

c.) A second aliquot comprising 100 mL of water is heated to 50 degrees C.

d.) 15 g calcium carbonate is added to the second aliquot of heated water to form a slurry.

e.) The calcium carbonate slurry is slowly added to the acid solution with stirring and is mixed until there is no further evidence of reaction as indicated by an absence of carbon dioxide evolution.

f.) The resulting mixture is freeze dried and then ground into a fine powder

g.) 3.43 g of the powder and 0.111 g calcium chloride is added to 1000 mL of water with stirring until the powder and calcium chloride is dissolved.

### Example 5

1000 mL of calcium fortified water having an average hedonic score of at least 5 and containing 520 ppm calcium is made as follows:

a.) 0.171 g citric acid and 0.156 g fumaric acid is added to 800 mL of water with stirring until the acids are dissolved.

b.) 0.192 g calcium hydroxide is added to 50 mL of water with stirring

c.) The calcium hydroxide solution is added to the acid solution.

d.) 1.981 g of calcium lactate is added to 150 mL of water with stirring.

e.) The calcium lactate solution is added to the calcium hydroxide and acid solution and mixed until clear to form a calcium fortified water containing 520 ppm calcium.

### Example 6

1000 mL of calcium fortified water having an average hedonic score of at least 5 and containing 440 ppm calcium is made as follows:

a.) 0.12 g calcium succinate, 0.083 g calcium chloride, 0.102 g calcium sulfate, and 3.759 g calcium gluconate is added to 1000 mL of water.

b.) The solution is stirred until the solution is clear.

### Example 7

1000 mL of calcium fortified water having an average hedonic score of at least 5 and containing 350 ppm calcium is made as follows:

a.) 0.542 g citric acid and 0.568 g malic acid are added to 40 mL of water.

b.) The citric acid, malic acid and water mixture is heated to 50 degrees C.

c.) 130 mL of water containing 0.407 g calcium hydroxide is slowly added to the citric acid, malic acid and water mixture and stirred for an hour.

d.) The mixture of (c) is freeze dried and ground into a fine powder and added to 1000 mL of water.

e.) 0.275 g calcium carbonate and 0.0554 g calcium chloride are added to 100 mL of the mixture formed in step (d) to which is added while stirring.

f.) The mixture of step (e) is added to the remaining 900 mL of the mixture formed in step (d) and stirred until the solution is clear.

### Example 8

1000 mL of calcium fortified water having an average hedonic score of at least 5 and containing 341 ppm calcium is made as follows:

a.) 1.375 g calcium gluconate and 0.697 g calcium lactate are added to a first 500 mL aliquot of water and the mixture is thoroughly stirred.

b.) 0.146 g mono basic calcium phosphate, 0.085 g calcium sulfate, 0.069 g calcium chloride, and 0.014 g calcium oxide are added to a second 500 mL aliquot of water and the mixture is thoroughly stirred.

c.) Mixtures 1 and 2 are combined and stirred until clear.

### Example 9

650 mL of carbonated, calcium fortified water having an average hedonic score of at least 5 and containing 507 ppm calcium is made as follows:

a.) 0.4 g malic acid, 0.193 g fumaric acid, and 0.211 g citric acid are added to 650 mL of water to form mixture A.

b.) 0.121 g calcium chloride dihydrate and 0.142 g calcium sulfate dihydrate are added to a 50 mL aliquot of mixture A to form mixture B.

c.) Mixture B is then added to the residual 600 mL of mixture A to form mixture C.

d.) 0.488 g calcium hydroxide is added to a 50 ml aliquot of mixture C to form mixture D.

e.) Mixture D is then added to the residual 600 mL of mixture C and stirred until clear to form a calcium fortified water containing 507 ppm calcium.

f.) The calcium fortified water of (e) is carbonated with 3 volumes of carbon dioxide to from a carbonated water.

### Example 10

1000 mL of calcium fortified water having an average hedonic score of at least 5 and containing 400 ppm calcium is made as follows:

a.) 200 mL of water is heated to 60 degrees C.

b.) 15.5 g lactic acid and 16.8 g gluconic acid are dissolved in the 200 mL of heated water.

c.) 150 mL of water is heated to 60 degrees C. and 9 g of calcium hydroxide is added to the 150 mL of heated water.

d.) While stirring, the calcium hydroxide mixture is added to the acid mixture. The resulting mixture stirred and kept at 60 degrees C. for 2 hours.

e.) The mixture of (d)is dried in an oven at 85 degrees until a constant temperature is reached.

f.) The dried mixture of (e) is ground into a fine powder.

g.) 3 g of the powder produced in step (f) is added to 1000 mL of water.

h.) 0.217 g calcium malate is added to the 1000 mL of solution produced in step (h) and stirred until clear.

### Example 11

1000 mL of calcium fortified water having an average hedonic score of at least 5 and containing 180 ppm calcium is made as follows:

a.) 0.134 g malic acid and 0.128 g citric acid are dissolved in 1000 mL of water.

b.) 0.2 g calcium carbonate, 0.170 g calcium sulfate, 0.138 g calcium chloride are added to the solution produced in step (a) and the mixture is stirred until clear.

### Example 12

10 L of calcium fortified water having an average hedonic score of at least 5 and containing 250 ppm calcium is made as follows:

a.) 2.871 g malic acid, 2.742 g citric acid, and 2.486 g fumaric acid are dissolved in 300 mL of water.

b.) A slurry comprising 50 mL of water and 5.625 g calcium carbonate is prepared.

c.) The slurry is slowly added to the acid solution and then the mixture is heated to 55 degrees C.

d.) The heated mixture is stirred for 3 hours, then dried and ground to a fine powder.

e.) The powder is added to 10 L of water and the mixture is stirred until the powder dissolves.

f.) 0.35 g CaO is added to the solution produced in step (e) and the mixture is stirred until clear.

### Example 13

10 L of calcium fortified water having an average hedonic score of at least 5 and containing 340 ppm calcium is made as follows:

A calcium fortified water is prepared as in example 12 except that 4.9 g calcium lactate is added prior to the addition of CaO.

### Example 14

1000 mL of calcium fortified water having an average hedonic score of at least 5 and containing 330 ppm calcium is made as follows:

a.) 250 g each of gluconic acid and citric acid are added to 1 L of water that has been heated to 50 degrees C.

b.) The acid solution is mixed until it is clear.

c.) A slurry containing of 250 g calcium carbonate in 0.5 L of water is prepared.

d.) The slurry produced in step (c) is heated to 50 degrees C. and slowly added to the acid mixture produced in step (a) with stirring.

e.) Mixture produced in step (d) is mixed for an additional 2 hours, centrifuged, and the solids are collected.

f.) The solids collected in step (e) are dried at 90 degrees C. to a moisture level of equal to or less 4% and then ground to a fine powder.

g.) 0.345 g of the powder produced in step (f), 0.319 g malic acid, 0.305 g citric, and 0.276 g fumaric acid are added to 1000 mL of water. The mixture is stirred to dissolve ingredients.

h.) 0.278 g calcium hydroxide and 0.102 g calcium sulfate are added to 100 mL of the mixture produced in step (g)

i.) The mixture produced in step (h) and the residual 900 mL of mixture (g) are combined and stirred until clear.

### Example 15

100 L of calcium fortified water having an average hedonic score of at least 5 and containing 200 ppm calcium is made as follows:

a.) Mixture A is made by combining 100 mL of water, 12.0 g fumaric acid, and 12.4 g lactic acid.

b.) Mixture B is made by combining 100 mL of water and 12.4 g calcium hydroxide.

c.) Both mixtures are heated to 60 degrees C. while stirring, and then slowly combined and stirred for an additional 1 hour.

d.) The combined mixture A and B is freeze dried and the resulting solids are ground to a fine powder.

e.) The powder formed during step (d) is combined with 2 L of water and stirred.

f.) The 2 L solution formed in step (e) is added to 90 L of water.

g.) 107.4 g calcium gluconate is added to 5 L of water and then added to the solution of step (f).

h.) 9.139 g calcium chloride is added to 3 L of water and this solution is added to the solution produced during step (g) to form a solution that is stirred until clear.

### Example 16

1000 mL of calcium fortified, sparkling water having an average hedonic score of at least 5 and containing 600 ppm calcium is made as follows:

a.) 1.005 g citric acid is added to 1000 mL of water which is mixed until the acid is dissolved.

b.) 1.053 g malic acid is added to the mixture formed in step (a) and the resulting mixture is stirred until the malic acid dissolves.

c.) 1.111 g calcium hydroxide is added to 100 mL of mixture formed in step (b) and the resulting mixture is stirred.

d.) The mixture formed in step (c) is added to the remaining 900 mL of solution formed during step (b) and the resulting mixture is mixed until clear.

e.) The solution formed in step (d) is carbonated with 4 volumes of carbon dioxide.

### Example 17

591 mL of calcium fortified water having an average hedonic score of at least 5 and containing 558 ppm calcium is made as follows:

a.) 0.442 g malic acid and 0.422 citric acid are added to 500 mL of water and the resulting mixture is mixed until the acids dissolve.

b.) 0.142 g calcium sulfate dihydrate, 0.121 g calcium chloride dihydrate, and 0.659 g calcium carbonate are added to 91 mL of water with stirring to form a slurry.

c.) The slurry is added to the acid mixture and the resulting mixture is mixed until all solids dissolve.

### Example 18

591 mL of calcium fortified water having an average hedonic score of at least 5 and containing 558 ppm calcium is made as follows:

a.) 0.442 g malic acid and 0.422 citric acid are added to 500 mL of water and the resulting mixture is mixed until the acids dissolve.

b.) 0.142 g calcium sulfate dihydrate, 0.121 g calcium chloride dihydrate, and 0.488 g calcium hydroxide are added to 91 mL of water with stirring to form a slurry.

c.) The slurry formed in step (b) is added to acid mixture formed in step (a) and the resulting mixture is mixed until the solids dissolve.

### Example 19

3.9 L of calcium fortified water having an average hedonic score of at least 5 and containing 170 ppm calcium is made as follows:

a.) 48 g citric acid and 50.25 g malic acid are added to 200 ml of water.

b.) The acid solution produced in step(a) is stirred while 75 g of calcium carbonate is slowly added

c.) The mixture formed in step (b) is heated to 45 degrees C. and stirred for an additional 2 hours.

d.) The mixture formed during step (c) is dried at 85 degrees C. to a moisture content of no more than 5% and then ground to a fine powder.

e.) 1.46 g citric acid and 1.53 g malic acid are dissolved in 100 mL of water.

f.) 0.889 g calcium hydroxide is added to the acid solution formed during step (e) and the resulting mixture is mixed until clear.

g.) The mixture formed during step (f) is added to 3.9 L of water. Then 1.0 g of the powder formed during step (d) is added and the resulting mixture is mixed to dissolve the solids.

### Example 20

500 mL of calcium fortified water having an average hedonic score of at least 5 and containing 158 ppm calcium is made as follows:

a.) 0.142 g calcium sulfate dihydrate, 0.121 g calcium chloride dihydrate, and 0.072 g calcium lactate are added to 100 mL of water.

b.) The mixture formed during step (a) is mixed with 400 mL of water.

### Example 21

1000 mL of calcium fortified, sparkling water having an average hedonic score of at least 5 and containing 145 ppm calcium is made as follows:

a.) 0.21 g adipic acid, 0.17 g succinic acid, and 0.13 g pyruvic acid are dissolved in 1 L of water.

b.) 0.269 g calcium hydroxide is added to a 50 mL aliquot of the acid solution formed during step (a).

c.) The 50 mL mixture formed during step (b) is added to the residual 950 ml of acid solution from step (a) and the resulting solution is mixed until clear

d.) The solution formed during step (c) is carbonated with 3.5 volumes of carbon dioxide.

### Example 22

Calcium fortified water having an average hedonic score of at least 5 and containing 90 ppm calcium is made as follows:

a.) 11.80 g citric acid, 12.54 g malic acid, and 11.23 g of lactic acid are dissolved in 140 mL of water.

b.) 18.5 g of calcium hydroxide is added to the acid solution formed during step (a) and the resulting mixture is stirred for 3 hours.

c.) The mixture formed during step (b) is centrifuged and the solids are collected, freeze dried and ground to a fine powder.

d.) 1 part of the powder formed during step (c) is added to 2000 parts water to form a calcium fortified water containing 90 ppm calcium.

### Example 23

1200 mL of calcium fortified water having an average hedonic score of at least 5 and containing 140 ppm calcium is made as follows:

a.) 11.80 g citric acid, 12.54 g malic acid, and 11.23 g of lactic acid are dissolved in 140 ML of water.

b.) 18.5 g of calcium hydroxide is added to the acid solution formed during step (a) and the resulting mixture is stirred for 3 hours.

c.) The mixture formed during step (b) is centrifuged and the solids are collected, freeze dried and ground to a fine powder.

d.) 0.27 g of the powder formed during step (c) is dissolved in 1.2 L of water.

e.) 0.537 g calcium gluconate, 0.069 g calcium chloride, and 0.085 g calcium sulfate are added to the mixture formed during step (d).

f.) 0.06 g fumaric acid is dissolved in 50 mL of the solution formed during step (e). Then 0.05 g calcium carbonate is added while stirring.

g.) The mixture formed during step (f) is added to the remaining 1.150 L of the solution formed during step (d).

### Example 24

A calcium fortified water product of the present invention is prepared as follows:

| Ingredients | Weight % |
|---|---|
| Water | 94.26 |
| Calcium Hydroxide | 2.07 |
| Citric Acid | 1.79 |
| Malic Acid | 1.88 |

The citric and malic acids are dissolved in 50% of the water. The calcium hydroxide is slurried into the remaining 50% of the water. The acid solution is slowly poured into the calcium hydroxide slurry, while mixing. Mix until solution becomes clear. The resulting calcium citrate malate premix solution has a calcium: citrate: malate ratio of 6:2:3. The premix solution may optionally be passed through a microfiltration system.

In order to obtain a 40% additional fortification level per liter of water, 3.374% of the calcium citrate malate premix solution is added to 96.626% of pre-sterilized or post-sterilized water.

In order to obtain a 100% additional fortification level per liter of water, 8.434% of the calcium citrate malate premix solution is add to 91.566% pre-sterilized or post-sterilized water.

### Example 25

A calcium fortified water product of the present invention is prepared as follows:

| Ingredients | Weight % |
|---|---|
| Water | 94.26 |
| Calcium Carbonate | 2.49 |
| Citric Acid | 1.59 |
| Malic Acid | 1.66 |

The citric and malic acids are dissolved in 50% of the water. The calcium carbonate is slurried into the remaining 50% of the water. The acid solution is slowly poured into the calcium carbonate slurry, while mixing. Mix until solution becomes clear. The resulting calcium citrate malate premix solution has a calcium: citrate: malate ratio of 6:2:3. The premix solution may optionally be passed through a microfiltration system.

In order to obtain a 40% additional fortification level per liter of water, 3.785% of the calcium citrate malate premix solution is added to 96.215% of pre-sterilized or post-sterilized water.

In order to obtain a 100% additional fortification level per liter of water, 9.463% of the calcium citrate malate premix solution is add to 90.537% pre-sterilized or post-sterilized water.

### Example 26

A calcium fortified water product of the present invention is prepared as follows:

For every liter of calcium fortified water product desired, use one liter of sterilized water or spring water, 2.31 grams calcium hydroxide, 2.00 grams citric acid, and 2.09 grams malic acid. Dissolve the citric and malic acids in 90% of the water to form an aqueous acid solution. An aqueous calcium salt slurry is prepared by adding the calcium hydroxide into the remaining 10% of the water and transferring, with mixing, to the acid solution until the mixture becomes clear. The calcium citrate malate fortified water may optionally be carbonated, flavored, and/or sweetened as desired, and may also optionally be passed through a microfiltration system before final packaging.

The resulting calcium citrate malate fortified water has a calcum:citrate:malate mole ratio of 6:2:3 and is fortified to supply a 30% additional fortification level per 240 mL serving.

### Calcium Fortified Milk Products

The calcium fortified milk products of the present invention involve the use of a mixture of calcium with citric and malic acids, herein referred to as “calcium citrate malate”. The calcium citrate malate may consist of a mixture of a calcium salt with citric and malic acids, a mixture of calcium citrate and calcium malate, a calcium citrate malate salt made by the acid-base reaction between a calcium salt and citric and malic acids, or combinations thereof. It is important that the calcium citrate malate be soluble in the product matrix and/or have a particle size which is small enough so as to prevent the sensation of grittiness in the product.

Preferably, the calcium citrate malate is neutral, comprised entirely of citrate and malate anions. However, the calcium citrate malate may contain other acid anions in addition to citrate and malate. Such anions may include, for example, hydroxide, carbonate, lactate, phosphate, gluconate, acetate, sulfate, fumarate, chloride and mixtures thereof depending on the calcium source. The anions will affect the taste of the product and therefore should be kept within an acceptable taste threshold.

The specific ratios of calcium citrate malate will be defined as the ratio of calcium to citrate to malate. All ratios of calcium, citrate and malate are on a mole basis. The less calcium that is present in this molar ratio, the higher the solubility of the resultant powder. The molar ratio of calcium in the salts is from 2 to 8, the molar ratio of citrate ranges from 1 to 3, and the molar ratio of malate ranges from 1 to 5. The calcium to citrate to malate ratio can range from 2:1:1 to 8:2:1, however, the preferred ratio is 6:2:3. A calcium :citrate: malate mixture of 6:2:3 represents a form in which all of the carboxylic acid groups of citric and malic acid are neutralized with the calcium.

The molar ratio of calcium to total moles of citrate plus malate is from about 1:0.16 to about 1:13.5, preferably from about 1:0.25 to about 1:5, and most preferably from about 1:0.3 to about 1:3 in the finished product. The ratio of moles citrate to moles malate is from about 95:5 to 5:95, preferably from about 80:20 to 20:80, and most preferably from about 70:30 to 30:70 in the finished product.

A significant advantage of low acid beverages which are fortified with calcium citrate malate as a calcium source is that it permits formula flexibility in the selection of calcium such that the desired taste and texture properties can be achieved. The level at which the acid components are present and the ratio between the acids and calcium depend upon the product involved, the level of calcium desired, the source of the calcium, as well as the taste and texture properties desired. Calcium salts with high acid neutralizing capability, such as calcium hydroxide, calcium carbonate, and calcium oxide, will require a greater acid component to be used to achieve a perception of tartness in the final product as compared to using calcium phosphate or calcium sulfate. Conversely, a lower acid component will be used for products having little or no perception of tartness flavor in the final product. When calcium oxide, calcium hydroxide, and/or calcium carbonate are used, the portion of these calcium salts neutralized by citric and malic acids yield the by-products of carbon dioxide and/or water. The preferred source of calcium is calcium oxide, calcium hydroxide, and calcium carbonate. The most preferred calcium sources are calcium oxide and calcium hydroxide.

Preferably, the calcium citrate malate compositions for use in the products of this invention may be provided in a soluble aqueous premix. The water used in preparing the premix needs to be taken into account in the final product to meet the 8.25% MSNF requirement. Alternatively, the calcium citrate malate can be made, for example, by first dissolving citric and malic acids in the desired molar ratios in water. Calcium carbonate can then be added to the solution in such amount that the ratio of moles calcium to moles citrate and malate is as desired. The calcium citrate malate formed is collected, dried, and milled to the desired particle size and added to the product or to a component of the product which is subsequently blended into the final product. See U.S. Pat. No. 5,186,965 (Fox et al., issued Feb. 16, 1993) for a method of making a soluble calcium citrate malate. In order to enhance the solubility of this material in the low acid beverage, preferably milk, it may be necessary to reduce the particle size to 80 microns or less. The total amount of calcium, citric acid, and malic acid in the fortified milk product comes from the combination of such added components along with that indigenously present in the final product.

### Preparation of Calcium Fortified Milk Products

The calcium fortified low acid beverage products are made by preparing a premix of neutral calcium citrate malate. The premix is prepared by dissolving citric and malic acids in a vessel containing the appropriate amount of water. Calcium salt is added to a second vessel containing the appropriate amount of water to make an aqueous calcium salt slurry. The contents of the vessel containing the acid solution are slowly added to the vessel containing the calcium hydroxide slurry, with mixing, until all of the calcium appears to be dissolved. The calcium citrate malate has a molar ratio of calcium to total moles of citrate plus malate of from about 1:0.3 to about 1:13.5

The premix is then optionally filtered by passing it through a filtration system to remove any undissolved particles that may be present. The calcium citrate malate aqueous premix is then added directly to the low acid beverage product prior to pasteurization/sterilization or can be added in a post-pasteurization/sterilization step. A post pasteurization/sterilization process may optionally require further processing of the premix to achieve commercial sterility, for example, microfiltration, UV treatment. The amount of premix added to the low acid beverage depends upon the fortification level desired.

### EXAMPLES

The following examples illustrate the compositions of the present invention, but are not intended to be limiting thereof.

### Example 1

A calcium fortified milk product of the present invention is prepared as follows:

| Ingredients | Weight % |
|---|---|
| Water | 94.26 |
| Calcium Hydroxide | 2.07 |
| Citric Acid | 1.79 |
| Malic Acid | 1.88 |

The citric and malic acids are dissolved in 50% of the water. The calcium hydroxide is slurried into the remaining 50% of the water. The acid solution is slowly poured into the calcium hydroxide slurry, while mixing. Mix until solution becomes clear. The resulting calcium citrate malate premix solution has a calcium: citrate: malate ratio of 6:2:3. The premix solution may optionally be passed through a microfiltration system.

In order to obtain a 40% additional fortification level in milk, 4.32% of the calcium citrate malate premix solution which contains 0.09% calcium is added to 95.68% of pre-pasteurized or post-pasteurized milk.

In order to obtain a 100% additional fortification level in milk, 10.81% of the calcium citrate malate premix solution which contains 0.22% calcium is added to 89.19% post-pasteurized milk.

### Example 2

A calcium fortified milk product of the present invention is prepared as follows:

| Ingredients | Weight % |
|---|---|
| Water | 94.26 |
| Calcium Carbonate | 2.49 |
| Citric Acid | 1.59 |
| Malic Acid | 1.66 |

The citric and malic acids are dissolved in 50% of the water. The calcium carbonate is slurried into the remaining 50% of the water. The acid solution is slowly poured into the calcium carbonate slurry, while mixing. Mix until solution becomes clear. The resulting calcium citrate malate premix solution has a calcium: citrate: malate ratio of 6:2:3. The premix solution may optionally be passed through a microfiltration system.

In order to obtain a 40% additional fortification level in milk, 4.32% of the calcium citrate malate premix solution which contains 0.09% calcium is added to 95.68% of pre-pasteurized or post-pasteurized milk.

In order to obtain a 100% additional fortification level in milk, 10.81% of the calcium citrate malate premix solution which contains 0.22% calcium is added to 89.19% post-pasteurized milk.

What is claimed is:

1. A calcium fortified low acid beverage product which comprises an additional 3% to about 100% RDA calcium per unit serving added as calcium citrate malate.

2. The product of claim 1 wherein the calcium citrate malate in the final product has a molar ratio of calcium to total moles of citrate plus malate of from about 1:0.16 to about 1:13.5.

3. The product of claim 2 wherein the ratio of moles citrate to moles of malate is from about 95:5 to about 5:95.

4. The product of claim 3 wherein the low acid beverage is milk.

5. The product of claim 3 wherein the low acid beverage is water.

6. The product of claim 3 wherein the low acid beverage is selected from the group consisting of milk, soy milk, water, protein-based beverages, meal replacement beverages, and mixtures thereof.

7. The product of claim 6 wherein the final composition contains additional anions other than citrate and malate selected from the group consisting of hydroxide, carbonate, lactate, phosphate, gluconate, acetate, sulfate, fumarate, chloride and mixtures thereof.

8. The product of claim 7 wherein the calcium citrate malate has a molar ratio of calcium to total moles of citrate plus malate of from about 1:0.25 to about 1:3.

9. The product of claim 8 wherein the ratio of moles citrate to moles of malate is from about 80:20 to about 20:80.

10. The product of claim 9 wherein the calcium citrate malate has a molar ratio of calcium to total moles of citrate plus malate of from about 1:0.3 to about 1:3.

11. The product of claim 10 wherein the ratio of moles citrate to moles of malate is from about 70:30 to about 30:70.

12. The product of claim 11 wherein the calcium citrate malate comprises a dry blend of citric acid, malic acid, and a calcium source selected from the group consisting of calcium hydroxide, calcium carbonate, calcium oxide, calcium phosphate, calcium lactate, calcium gluconate, calcium acetate, calcium sulfate, calcium fumarate, calcium chloride and combinations thereof.

13. The product of claim 12 wherein the molar ratio of calcium is from 4 to 8, of citrate is from 1 to 3, and the molar ratio of malic acid is from 1 to 5.

14. The product of claim 13 wherein the molar ratio of calcium:citrate:malate is 6:2:3.

15. The product of claim 14 wherein the additional calcium is from 10% to 40% of the RDA per unit serving.

16. The product of claim 15 wherein the additional calcium is added to pre-pasteurized low acid beverage.

17. The product of claim 15 wherein the additional calcium is added to post-pasteurized low acid beverage.

18. The product of claim 14 wherein the additional calcium is from 40% to 100% of the RDA per unit serving.

19. The product of claim 18 wherein the additional calcium is added to post-pasteurized low acid beverage.

20. The product of claim 15 wherein the calcium fortified milk has a pH of from about 6.5 to about 7.0.

21. The product of claim 18 wherein the calcium fortified milk has a pH of from about 6.5 to about 7.0.

22. A process for producing a calcium fortified milk product comprising the steps of:
a) preparing an aqueous premix of neutral calcium citrate malate;
b) adding said premix directly to milk prior to pasteurization; and
c) achieving the appropriate weight ratio to meet the required 8.25% milk solids non-fat standard;
wherein the calcium citrate malate has a molar ratio of calcium to total moles of citrate plus malate of from about 1:0.3 to about 1:13.5.

23. A process for producing a calcium fortified milk product comprising the steps of:
a) preparing an aqueous premix of neutral calcium citrate malate;
b) adding said premix directly to pasteurized milk; and
c) achieving the appropriate weight ratio to meet the required 8.25% milk solids non-fat standard;
wherein the calcium citrate malate has a molar ratio of calcium to total moles of citrate plus malate of from about 1:0.3 to about 1:13.5.

24. A process for producing a calcium fortified milk product comprising the steps of:
a) preparing an aqueous premix of neutral calcium citrate malate;
b) processing said premix to achieve commercial sterility;
c) adding said premix directly to pasteurized milk; and
d) achieving the appropriate weight ratio to meet the required 8.25% milk solids non-fat standard;
wherein the calcium citrate malate has a molar ratio of calcium to total moles of citrate plus malate of from about 1:0.3 to about 1:13.5.

25. A calcium fortified milk product produced by the process comprising the steps of:
a) preparing an aqueous premix of neutral calcium citrate malate;
b) adding said premix directly to milk prior to pasteurization; and
c) achieving the appropriate weight ratio to meet the required 8.25% milk solids non-fat standard;
wherein the calcium citrate malate has a molar ratio of calcium to total moles of citrate plus malate of from about 1:0.3 to about 1:13.5.

26. A calcium fortified milk product produced by the process comprising the steps of:
a) preparing an aqueous premix of neutral calcium citrate malate;
b) adding said premix directly to pasteurized milk; and
c) achieving the appropriate weight ratio to meet the required 8.25% milk solids non-fat standard;
wherein the calcium citrate malate has a molar ratio of calcium to total moles of citrate plus malate of from about 1:0.3 to about 1:13.5.

27. A calcium fortified milk product produced by the process comprising the steps of:
a) preparing an aqueous premix of neutral calcium citrate malate;
b) processing said premix to achieve commercial sterility;
c) adding said processed premix directly to pasteurized milk; and
d) achieving the appropriate weight ratio to meet the required 8.25% milk solids non-fat standard;
wherein the calcium citrate malate has a molar ratio of calcium to total moles of citrate plus malate of from about 1:0.3 to about 1:13.5.

28. A calcium fortified water composition comprising water and a sufficient amount of an added calcium source to provide said calcium fortified water composition with a total elemental calcium concentration of from about 1 ppm to about 850 ppm.

29. The calcium fortified water composition of claim 28 wherein said added calcium source is selected from the group consisting of:
a.) an organic acid salt of calcium;
b.) a mixed organic acid salt of calcium;
c.) a mixture comprising an acidic calcium salt and an organic acid salt of calcium;
d.) a mixture comprising an acidic calcium salt and a mixed organic acid salt of calcium;
e.) a mixture comprising an acidic calcium salt, an organic acid salt of calcium and a mixed organic acid salt of calcium;
f.) a mixture comprising an acidic calcium salt, a basic calcium salt and an organic acid;
g.) a mixture comprising an acidic calcium salt, a basic calcium salt, an organic acid and a mixed organic acid salt of calcium;
h.) a mixture comprising an acidic calcium salt, a basic calcium salt, an organic acid and an organic acid salt of calcium;
i.) a mixture comprising an acidic calcium salt, a basic calcium salt, an organic acid, an organic acid salt of calcium and a mixed organic acid salt of calcium;
j.) a mixture comprising a basic calcium salt and at least two organic acids;
k.) a mixture comprising a basic calcium salt and an organic acid salt of calcium;
l.) a mixture comprising a basic calcium salt and a mixed organic acid salt of calcium;
m.) a mixture comprising an organic acid salt of calcium and a mixed organic acid salt of calcium;
n.) a mixture comprising a basic calcium salt, an organic acid salt of calcium and a mixed organic acid salt of calcium;
o.) a mixture comprising a basic calcium salt, an organic acid and an organic acid salt of calcium;
p.) a mixture comprising a basic calcium salt, an organic acid and a mixed organic acid salt of calcium;
q.) a mixture comprising a basic calcium salt, an organic acid, an organic acid salt of calcium and a mixed organic acid salt of calcium; and
r.) mixtures thereof;
wherein said added calcium source is present in a sufficient amount to provide said calcium fortified water composition with a total elemental calcium concentration of from about 511 to about 850 ppm.

30. The calcium fortified water composition of claim 29 wherein said calcium source is selected from the group consisting of:
a.) a mixture comprising an acidic calcium salt and an organic acid salt of calcium;
b.) a mixture comprising an acidic calcium salt and a mixed organic acid salt of calcium;
c.) a mixture comprising an acidic calcium salt, an organic acid salt of calcium and a mixed organic acid salt of calcium;
d.) a mixture comprising an acidic calcium salt, a basic calcium salt and an organic acid;
e.) a mixture comprising an acidic calcium salt, a basic calcium salt, an organic acid and a mixed organic acid salt of calcium;
f.) a mixture comprising an acidic calcium salt, a basic calcium salt, an organic acid and an organic acid salt of calcium;
g.) a mixture comprising an acidic calcium salt, a basic calcium salt, an organic acid, an organic acid salt of calcium and a mixed organic acid salt of calcium; and
h.) mixtures thereof;
wherein from about 1% to about 40% of the total elemental calcium concentration of said calcium fortified water composition is obtained from an acidic calcium salt or mixtures of acidic calcium salts.

31. The calcium fortified water composition of claim 30 wherein from about 1% to about 30% of the total elemental calcium concentration of said calcium fortified water composition is obtained from an acidic calcium salt or mixtures of acidic calcium salts.

32. The calcium fortified water composition of claim 31 wherein from about 5% to about 20% of the total elemental calcium concentration of said calcium fortified water composition is obtained from an acidic calcium salt or mixtures of acidic calcium salts.

33. The calcium fortified water composition of claim 28 wherein said added calcium source is selected from the group consisting of:
a.) an organic acid salt of calcium;
b.) a mixed organic acid salt of calcium;
c.) a mixture comprising an acidic calcium salt and an organic acid salt of calcium;
d.) a mixture comprising an acidic calcium salt and a mixed organic acid salt of calcium;
e.) a mixture comprising an acidic calcium salt, an organic acid salt of calcium and a mixed organic acid salt of calcium;
f.) a mixture comprising an acidic calcium salt, a basic calcium salt and an organic acid;
g.) a mixture comprising an acidic calcium salt, a basic calcium salt, an organic acid and a mixed organic acid salt of calcium;
h.) a mixture comprising an acidic calcium salt, a basic calcium salt, an organic acid and an organic acid salt of calcium;
i.) a mixture comprising an acidic calcium salt, a basic calcium salt, an organic acid, an organic acid salt of calcium and a mixed organic acid salt of calcium;
j.) a mixture comprising a basic calcium salt and at least two organic acids;
k.) a mixture comprising a basic calcium salt and an organic acid salt of calcium;
l.) a mixture comprising a basic calcium salt and a mixed organic acid salt of calcium;
m.) a mixture comprising an organic acid salt of calcium and a mixed organic acid salt of calcium;
n.) a mixture comprising a basic calcium salt, an organic acid salt of calcium and a mixed organic acid salt of calcium;
o.) a mixture comprising a basic calcium salt, an organic acid and an organic acid salt of calcium;
p.) a mixture comprising a basic calcium salt, an organic acid and a mixed organic acid salt of calcium;
q.) a mixture comprising a basic calcium salt, an organic acid, an organic acid salt of calcium and a mixed organic acid salt of calcium; and
r.) mixtures thereof;
wherein said added calcium source is present in a sufficient amount to provide said calcium fortified water composition with a total elemental calcium concentration of from about 341 to about 511 ppm.

34. The calcium fortified water composition of claim 33 wherein said calcium source is selected from the group consisting of:
a.) a mixture comprising an acidic calcium salt and an organic acid salt of calcium;
b.) a mixture comprising an acidic calcium salt and a mixed organic acid salt of calcium;
c.) a mixture comprising an acidic calcium salt, an organic acid salt of calcium and a mixed organic acid salt of calcium;
d.) a mixture comprising an acidic calcium salt, a basic calcium salt and an organic acid;
e.) a mixture comprising an acidic calcium salt, a basic calcium salt, an organic acid and a mixed organic acid salt of calcium;
f.) a mixture comprising an acidic calcium salt, a basic calcium salt, an organic acid and an organic acid salt of calcium;
g.) a mixture comprising an acidic calcium salt, a basic calcium salt, an organic acid, an organic acid salt of calcium and a mixed organic acid salt of calcium; and
h.) mixtures thereof;
wherein from about 1% to about 60% of the total elemental calcium concentration of said calcium fortified water composition is obtained from an acidic calcium salt or mixtures of acidic calcium salts.

35. The calcium fortified water composition of claim 34 wherein from about 1% to about 45% of the total elemental calcium concentration of said calcium fortified water composition is obtained from an acidic calcium salt or mixtures of acidic calcium salts.

36. The calcium fortified water composition of claim 35 wherein from about 5% to about 25% of the total elemental calcium concentration of said calcium fortified water composition is obtained from an acidic calcium salt or mixtures of acidic calcium salts.

37. The calcium fortified water composition of claim 28 wherein said added calcium source is selected from the group consisting of:
a.) an organic acid salt of calcium;
b.) a mixed organic acid salt of calcium;
c.) a mixture comprising an acidic calcium salt and an organic acid salt of calcium;
d.) a mixture comprising an acidic calcium salt and a mixed organic acid salt of calcium;
e.) a mixture comprising an acidic calcium salt, an organic acid salt of calcium and a mixed organic acid salt of calcium;
f.) a mixture comprising an acidic calcium salt, a basic calcium salt and an organic acid;
g.) a mixture comprising an acidic calcium salt, a basic calcium salt, an organic acid and a mixed organic acid salt of calcium;
h.) a mixture comprising an acidic calcium salt, a basic calcium salt, an organic acid and an organic acid salt of calcium;
i.) a mixture comprising an acidic calcium salt, a basic calcium salt, an organic acid, an organic acid salt of calcium and a mixed organic acid salt of calcium;
j.) a mixture comprising a basic calcium salt and at least two organic acids;
k.) a mixture comprising a basic calcium salt and an organic acid salt of calcium;
l.) a mixture comprising a basic calcium salt and a mixed organic acid salt of calcium;
m.) a mixture comprising an organic acid salt of calcium and a mixed organic acid salt of calcium;
n.) a mixture comprising a basic calcium salt, an organic acid salt of calcium and a mixed organic acid salt of calcium;
o.) a mixture comprising a basic calcium salt, an organic acid and an organic acid salt of calcium;
p.) a mixture comprising a basic calcium salt, an organic acid and a mixed organic acid salt of calcium;
q.) a mixture comprising a basic calcium salt, an organic acid, an organic acid salt of calcium and a mixed organic acid salt of calcium; and
r.) mixtures thereof;
wherein said added calcium source is present in a sufficient amount to provide said calcium fortified water composition with a total elemental calcium concentration of from about 171 to about 341 ppm.

38. The calcium fortified water composition of claim 37 wherein said calcium source is selected from the group consisting of:
a.) a mixture comprising an acidic calcium salt and an organic acid salt of calcium;
b.) a mixture comprising an acidic calcium salt and a mixed organic acid salt of calcium;
c.) a mixture comprising an acidic calcium salt, an organic acid salt of calcium and a mixed organic acid salt of calcium;
d.) a mixture comprising an acidic calcium salt, a basic calcium salt and an organic acid;
e.) a mixture comprising an acidic calcium salt, a basic calcium salt, an organic acid and a mixed organic acid salt of calcium;
f.) a mixture comprising an acidic calcium salt, a basic calcium salt, an organic acid and an organic acid salt of calcium;
g.) a mixture comprising an acidic calcium salt, a basic calcium salt, an organic acid, an organic acid salt of calcium and a mixed organic acid salt of calcium; and
h.) mixtures thereof;
wherein from about 1% to about 90% of the total elemental calcium concentration of said calcium fortified water composition is obtained from an acidic calcium salt or mixtures of acidic calcium salts.

39. The calcium fortified water composition of claim 38 wherein from about 1% to about 65% of the total elemental calcium concentration of said calcium fortified water composition is obtained from an acidic calcium salt or mixtures of acidic calcium salts.

40. The calcium fortified water composition of claim 39 wherein from about 5% to about 30% of the total elemental calcium concentration of said calcium fortified water composition is obtained from an acidic calcium salt or mixtures of acidic calcium salts.

41. The calcium fortified water composition of claim 28 wherein said added calcium source is selected from the group consisting of:
a.) a mixed organic acid salt of calcium;
b.) a mixture comprising an acidic calcium salt and an organic acid salt of calcium;
c.) a mixture comprising an acidic calcium salt and a mixed organic acid salt of calcium;
d.) a mixture comprising an acidic calcium salt, an organic acid salt of calcium and a mixed organic acid salt of calcium;
e.) a mixture comprising an acidic calcium salt, a basic calcium salt and an organic acid;
f.) a mixture comprising an acidic calcium salt, a basic calcium salt, an organic acid and a mixed organic acid salt of calcium;
g.) a mixture comprising an acidic calcium salt, a basic calcium salt, an organic acid and an organic acid salt of calcium;
h.) a mixture comprising an acidic calcium salt, a basic calcium salt, an organic acid, an organic acid salt of calcium and a mixed organic acid salt of calcium;
i.) a mixture comprising a basic calcium salt and an organic acid salt of calcium;
j.) a mixture comprising a basic calcium salt and a mixed organic acid salt of calcium;
k.) a mixture comprising an organic acid salt of calcium and a mixed organic acid salt of calcium;
l.) a mixture comprising a basic calcium salt, an organic acid salt of calcium and a mixed organic acid salt of calcium;
n.) a mixture comprising a basic calcium salt, an organic acid and an organic acid salt of calcium;
m.) a mixture comprising a basic calcium salt, an organic acid and a mixed organic acid salt of calcium;
o.) a mixture comprising a basic calcium salt, an organic acid, an organic acid salt of calcium and a mixed organic acid salt of calcium;
p.) an organic acid salt of calcium;
q.) a mixture comprising an acidic calcium salt and a basic calcium salt;
r.) a mixture comprising an acidic calcium salt, a basic calcium salt and an organic acid salt of calcium;
s.) a mixture comprising an acidic calcium salt, a basic calcium salt and a mixed organic acid salt of calcium;
t.) a mixture comprising an acidic calcium salt, a basic calcium salt, an organic acid salt of calcium and a mixed organic acid salt of calcium;
u.) a mixture comprising a basic calcium salt and at least two organic acids; and
v.) mixtures thereof;
wherein said added calcium source is present in a sufficient amount to provide said calcium fortified water composition with a total elemental calcium concentration of from about 1 ppm to about 171 ppm.

42. A calcium fortified water composition comprising water and a sufficient amount of an added calcium source to provide said calcium fortified water composition with a total elemental calcium concentration of from about 1 ppm to about 850 ppm, wherein said calcium fortified water has an average hedonics score of at least 5.

43. A calcium fortified water composition consisting essentially of water and a sufficient amount of an added calcium source to provide said calcium fortified water composition with a total elemental calcium concentration of from about 1 ppm to about 850 ppm.

44. The calcium fortified water composition of claim 43 wherein said added calcium source is selected from the group consisting of:
a.) an acidic calcium salt;
b.) a mixture comprising a basic calcium salt and an organic acid; and
c.) a basic calcium salt;
wherein said added calcium source is present in a sufficient amount to provide said calcium fortified water composition with a total elemental calcium concentration of from about 1 ppm to about 171 ppm.

45. The calcium fortified water composition of claim 43 wherein said added calcium source is a mixture consisting essentially of a basic calcium salt and an organic acid; and wherein said added calcium source is present in a sufficient amount to provide said calcium fortified water composition with a total elemental calcium concentration of from about 171 ppm to about 850 ppm.

46. A calcium source composition comprising at least one member selected from the group consisting of:
a.) a mixed organic acid salt of calcium;
b.) a mixture comprising an acidic, calcium salt and an organic acid salt of calcium;
c.) a mixture comprising an acidic calcium salt and a mixed organic acid salt of calcium;
d.) a mixture comprising an acidic calcium salt, an organic acid salt of calcium and a mixed organic acid salt of calcium;
e.) a mixture comprising an acidic calcium salt, a basic calcium salt and an organic acid;
f.) a mixture comprising an acidic calcium salt, a basic calcium salt, an organic acid and a mixed organic acid salt of calcium;
g.) a mixture comprising an acidic calcium salt, a basic calcium salt, an organic acid and an organic acid salt of calcium;
h.) a mixture comprising an acidic calcium salt, a basic calcium salt, an organic acid, an organic acid salt of calcium and a mixed organic acid salt of calcium;
i.) a mixture comprising a basic calcium salt and an organic acid salt of calcium;
j.) a mixture comprising a basic calcium salt and a mixed organic acid salt of calcium;
k.) a mixture comprising an organic acid salt of calcium and a mixed organic acid salt of calcium;
l.) a mixture comprising a basic calcium salt, an organic acid salt of calcium and a mixed organic acid salt of calcium;
n.) a mixture comprising a basic calcium salt, an organic acid and an organic acid salt of calcium;
m.) a mixture comprising a basic calcium salt, an organic acid and a mixed organic acid salt of calcium;
o.) a mixture comprising a basic calcium salt, an organic acid, an organic acid salt of calcium and a mixed organic acid salt of calcium;
p.) an organic acid salt of calcium;
q.) a mixture comprising an acidic calcium salt and a basic calcium salt;
r.) a mixture comprising an acidic calcium salt, a basic calcium salt and an organic acid salt of calcium;
s.) a mixture comprising an acidic calcium salt, a basic calcium salt and a mixed organic acid salt of calcium;
t.) a mixture comprising an acidic calcium salt, a basic calcium salt, an organic acid salt of calcium and a mixed organic acid salt of calcium;
u.) a mixture comprising a basic calcium salt and at least two organic acids; and
v.) mixtures thereof.

47. A calcium source composition consisting essentially of at least one member selected from the group consisting of:
a.) a basic calcium salt
b.) a mixture comprising a basic calcium salt and an organic acid; and
c.) an acidic calcium salt.

48. A process for producing a calcium fortified water composition that contains a sufficient amount of an added calcium source to provide said calcium fortified water composition with a total elemental calcium concentration of 850 ppm or less, the process comprising the steps of:
a.) providing a calcium source wherein said calcium source's components are selected from the group consisting of acidic calcium salts, basic calcium salts, organic acids, organic acid salts of calcium, mixed organic acid salts of calcium and mixtures thereof; adding water to said calcium source.

49. The process of claim 48 comprising the further step of processing said calcium fortified water composition to achieve microbial stability.

50. A process for producing a calcium fortified water composition that contains a sufficient amount of an added calcium source to provide said calcium fortified water composition with a total elemental calcium concentration of 850 ppm or less, the process comprising the steps of:
a.) providing a calcium source wherein said calcium source's components are selected from the group consisting of acidic calcium salts, basic calcium salts, organic acids, organic acid salts of calcium, mixed organic acid salts of calcium and mixtures thereof;
b.) adding said components of said calcium source to water.

51. The process of claim 50 comprising the further step of processing said calcium fortified water composition to achieve microbial stability.

52. The process of claim 51 wherein said organic acid or mixture of organic acids is added to water first.

53. A process for producing a calcium fortified water composition that contains a sufficient amount of an added calcium source to provide said calcium fortified water composition with a total elemental calcium concentration of 850 ppm or less, the process comprising the steps of:
a.) providing a calcium source wherein said calcium source's components are selected from the group consisting of acidic calcium salts, basic calcium salts, organic acids, organic acid salts of calcium, mixed organic acid salts of calcium and mixtures thereof;
b.) preparing at least one aqueous premix comprising at least one component of said calcium source;
c.) adding the premixes and any remaining components of said calcium source directly to water.

54. The process of claim 53 comprising the further step of processing said calcium fortified water composition to achieve microbial stability.

55. The process of claim 54 wherein any organic acid or mixtures of organic acids are added to said water before any premix or any other component of said calcium source.

56. The process of claim 55 wherein any premix that comprises at least one organic acid is added to said water after any organic acid or mixture of organic acids is added to said water but before the addition of any other component of said calcium source.

57. A process for producing a calcium fortified water composition comprising the steps of:
a) preparing an aqueous premix of calcium citrate malate;
b) adding said premix directly to water; and
c) achieving the appropriate weight ratio;
wherein the calcium citrate malate has a molar ratio of calcium to total moles of citrate plus malate of from about 1:0.3 to about 1:13.5.

58. A process for producing a calcium fortified water composition comprising the steps of:
a) preparing an aqueous premix of calcium citrate malate;
b) processing said premix to achieve microbial stability;
c) adding said premix directly to water; and
d) achieving the appropriate weight ratio;
wherein the calcium citrate malate has a molar ratio of calcium to total moles of citrate plus malate of from about 1:0.3 to about 1:13.5.

59. A process for producing a calcium fortified water composition comprising the steps of:
a) preparing an aqueous acid solution containing citric acid and malic acid;
b) preparing an aqueous calcium salt slurry; and
c) combining said aqueous acid solution with said aqueous calcium salt slurry to achieve a calcium citrate malate fortified water product;
wherein the calcium citrate malate has a molar ratio of calcium to total moles of citrate plus malate of from about 1:0.3 to about 1:13.5.

60. A process for producing a calcium fortified water composition comprising the steps of:
a) preparing an aqueous acid solution containing citric acid and malic acid; and
b) adding calcium salts directly to said aqueous acid solution to achieve a calcium citrate malate fortified water product;
wherein the calcium citrate malate has a molar ratio of calcium to total moles of citrate plus malate of from about 1:0.3 to about 1:13.5.
